(19) United States
(12) Patent Application Publication
(10) Pub. No.: US 2024/0348067 A1
(43) Pub. Date: Oct. 17, 2024

(54) ALL-SOLID-STATE BATTERY SYSTEM

(71) Applicant: TOYOTA JIDOSHA KABUSHIKI KAISHA, Toyota-shi (JP)

(72) Inventors: Mitsutoshi Otaki, Susono-shi (JP); Shinji Nakanishi, Mishima-shi (JP); Tetsuya Waseda, Susono-shi (JP); Jun Yoshida, Mishima-shi (JP); Tsubasa Migita, Osaka (JP); Yoshihiro Uchida, Nagakute-shi (JP)

(73) Assignee: TOYOTA JIDOSHA KABUSHIKI KAISHA, Toyota-shi (JP)

(21) Appl. No.: 18/406,483

(22) Filed: Jan. 8, 2024

(30) Foreign Application Priority Data
Apr. 13, 2023 (JP) 2023-065571

(51) Int. Cl. H02J 7/00; H01M 10/42; H01M 10/44; H01M 50/264

(52) U.S. Cl. CPC H02J 7/0029; H01M 10/425; H01M 10/44; H01M 50/264; H01M 2220/20

(57) ABSTRACT

The all-solid-state battery system includes an all-solid-state battery and an ECU (control device) that performs charge control and discharge control of the all-solid-state battery. If an internal short circuit is detected during charging control of the all-solid-state battery, the ECU switches charging control to discharging control and discharges the all-solid-state battery.

### CROSS-REFERENCE TO RELATED APPLICATION

This application claims priority to Japanese Patent Application No. 2023-065571 filed on Apr. 13, 2023, incorporated herein by reference in its entirety.

### BACKGROUND

### 1. Technical Field

The present disclosure relates to an all-solid-state battery system.

### 2. Description of Related Art

Japanese Unexamined Patent Application Publication No. 2019-145247 (JP 2019-145247 A) discloses a method of recovering the capacity of an all-solid-state battery by charging and discharging the all-solid-state battery in a state in which the all-solid-state battery is restrained by a high pressure.

### SUMMARY

Here, in an all-solid-state battery, metallic lithium may be deposited on a solid electrolyte layer due to a crack or the like in the solid electrolyte layer. When a cracked all-solid-state battery is charged, an internal short circuit may occur due to electrical connection between a positive electrode and a negative electrode of the all-solid-state battery through metallic lithium.

The present disclosure has been made to address the above issue. The purpose is to provide an all-solid-state battery system that can suppress the progress of an internal short circuit in an all-solid-state battery.

An aspect of the present disclosure provides an all-solid-state battery system including:
an all-solid-state battery; and
a control device that performs charge control and discharge control of the all-solid-state battery, in which
when an internal short circuit is detected during the charge control of the all-solid-state battery, the control device switches the charge control to the discharge control and discharges the all-solid-state battery.

In the all-solid-state battery system according to the aspect of the present disclosure, the all-solid-state battery is discharged when an internal short circuit is detected during charge control of the all-solid-state battery, as described above. Consequently, the deposited lithium that has been the cause of the internal short circuit can be dissolved by discharge. As a result, the progress of the internal short circuit in the all-solid-state battery can be suppressed.

In the all-solid-state battery system according to the above aspect, preferably,
when the internal short circuit is detected during the charge control of the all-solid-state battery, the control device may continue the discharge control until the all-solid-state battery is over-discharged.
With this configuration, the deposited metallic lithium can be more reliably dissolved by discharge. As a result, the progress of the internal short circuit in the all-solid-state battery can be more reliably suppressed.

Preferably, the all-solid-state battery system according to the above aspect may further include
a restraint jig for restraining the all-solid-state battery.
The control device may increase a restraint pressure by the restraint jig when the internal short circuit is detected during the charge control of the all-solid-state battery, compared to when the internal short circuit is not detected.
With this configuration, pieces of the all-solid-state battery can be joined to each other by the restraint pressure applied by the restraint jig in the part where the all-solid-state battery is cracked.

In this case, preferably,
the control device may increase the restraint pressure after the discharge control of the all-solid-state battery is completed.
With this configuration, it is possible to suppress the restraint pressure increasing before the deposited metallic lithium is dissolved. As a result, it is possible to suppress the promotion of an internal short circuit in the all-solid-state battery due to the elongation of the deposited metallic lithium due to the increase in the restraint pressure.

In the all-solid-state battery system according to the above aspect, preferably,
the control device may increase a discharge rate of the all-solid-state battery when the internal short circuit is detected during the charge control of the all-solid-state battery, compared to when the internal short circuit is not detected.
With this configuration, the speed of dissolving the deposited metallic lithium can be improved. Therefore, it is possible to quickly shift to the next charge control.

According to the present disclosure, it is possible to suppress the progress of an internal short circuit due to the deposition of metallic lithium in an all-solid-state battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating the configuration of an electrified vehicle including an all-solid-state battery system according to an embodiment;

FIG. 2 is a schematic diagram illustrating a battery including an all-solid-state battery and a restraint jig according to one embodiment;

FIG. 3 is a cross-sectional view of an all-solid-state battery according to one embodiment;

FIG. 4 is a cross-sectional view showing how metallic lithium is deposited in an all-solid-state battery;

FIG. 5 is a flow diagram illustrating a method for charging an all-solid-state battery according to one embodiment; and

FIG. 6 is a diagram showing a method for detecting an internal short circuit based on the amount of change in the voltage value of an all-solid-state battery.

### DETAILED DESCRIPTION OF EMBODIMENTS

Embodiments of the present disclosure will be described in detail below with reference to the drawings. Note that the same or corresponding parts in the figures are given the same reference numerals. Descriptions of the same or corresponding parts in the figures will not be repeated.

### Overall Structure

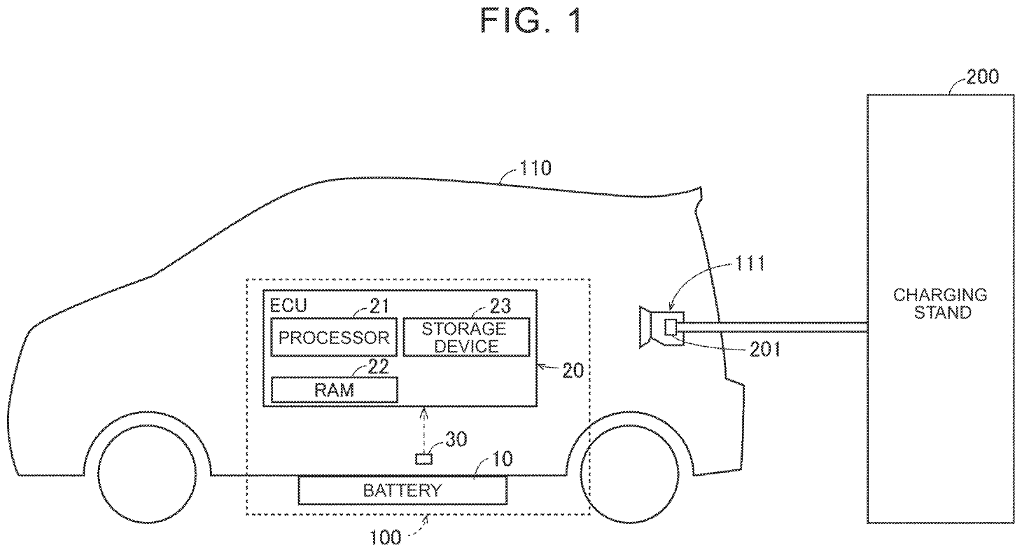

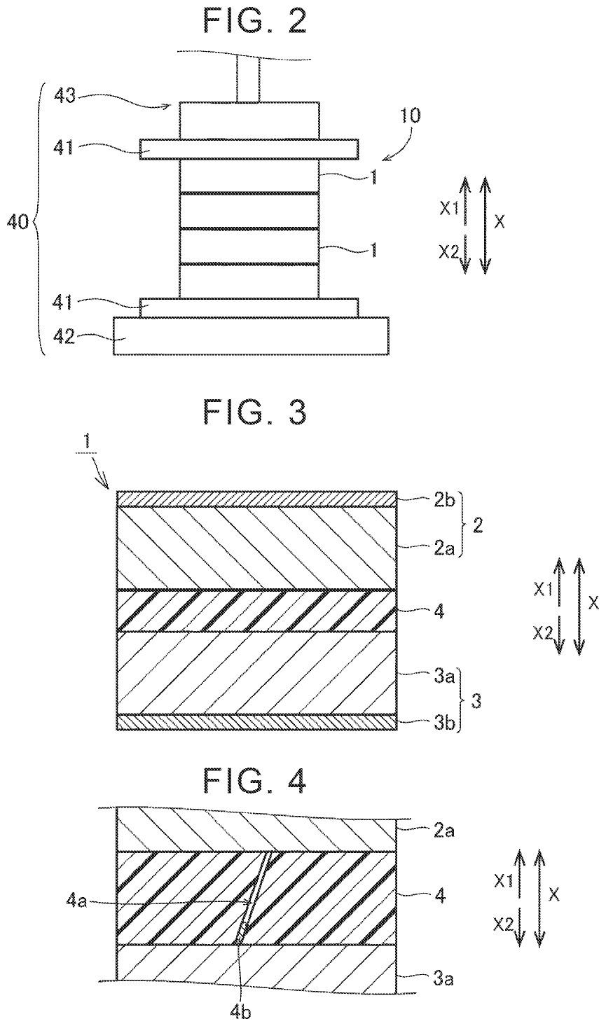

FIG. 1 is a diagram schematically showing the overall configuration of an electrified vehicle 110 including an all-solid-state battery system 100 according to the present embodiment. The all-solid-state battery system 100 includes a battery 10 including a plurality of all-solid-state batteries 1 (see FIG. 2). The all-solid-state battery 1 is a single battery cell. The all-solid-state battery system 100 also includes an Electronic Control Unit (ECU) 20, a monitoring module 30, and a restraint jig 40 (see FIG. 2). Note that the ECU 20 is an example of a “control device” of the present disclosure.

Note that the electrified vehicle 110 is configured to be able to run using electric power stored in the battery 10. The electrified vehicle 110 is a battery electric vehicle (BEV) without an engine (internal combustion engine). However, the electrified vehicle 110 may be a hybrid electric vehicle (HEV) with an engine or a plug-in hybrid electric vehicle (PHEV).

ECU 20 is configured to perform charging control and discharging control of battery 10 (all-solid-state battery 1). ECU 20 includes a processor 21, Random Access Memory (RAM) 22, and a storage device 23.

ECU 20 may be a computer. Processor 21 may be a Central Processing Unit (CPU). RAM 22 functions as a working memory that temporarily stores data processed by processor 21.

The storage device 23 is configured to be able to save stored information. The storage device 23 stores programs as well as information used in the programs (for example, maps, formulas, and various parameters). Various controls in the ECU 20 are executed by the processor 21 executing programs stored in the storage device 23.

The monitoring module 30 includes various sensors that detect the state (e.g., voltage, current, and temperature) of the battery 10 (all-solid-state battery 1). The monitoring module 30 outputs the detection results to the ECU 20. Specifically, the monitoring module 30 detects the voltage of each of the plurality of all-solid-state batteries 1 (see FIG. 2). In addition to the sensor function described above, the monitoring module 30 may further have a State of Charge (SOC) estimation function, a SOHState of Health (SOH) estimation function, a cell voltage equalization function, a diagnostic function, and a communication function. Based on the output of monitoring module 30, ECU 20 can obtain the status of battery 10 (e.g., temperature, current, voltage, SOC, and internal resistance).

The battery 10 is charged by the power supplied from the charging/discharging stand 200. Electric power supplied from the charging/discharging stand 200 is stored in the battery 10. Further, the battery 10 discharges the power stored in the battery 10 to the charging/discharging stand 200. Electric power supplied from the charging/discharging stand 200 to the battery 10 is transmitted through the charging plug 201 of the charging/discharging stand 200 connected to the charging port 111 of the electrified vehicle 110. Furthermore, the power supplied from the battery 10 to the charging/discharging stand 200 is transmitted through the charging plug 201 of the charging/discharging stand 200 connected to the charging port 111 of the electrified vehicle 110.

FIG. 2 is a diagram showing the overall configuration of the battery 10. The plurality of all-solid-state batteries 1 of the battery 10 are stacked in the X direction shown in FIG. 2. In the example shown in FIG. 2, four all-solid-state batteries 1 are stacked. Note that the number of all-solid-state batteries 1 is not particularly limited.

The plurality of all-solid-state batteries 1 are restrained in the X direction by a restraint jig 40. Thereby, a predetermined restraining pressure is applied to each of the plurality of all-solid-state batteries 1 in the X direction.

The restraint jig 40 includes a pair of plates 41 that sandwich the plurality of all-solid-state batteries 1 in the X direction. Furthermore, the restraint jig 40 includes a support part 42 that supports the plurality of all-solid-state batteries 1 (the plate 41 on the X2 side) from the X2 side. Furthermore, the restraint jig 40 includes a pressing part 43 (for example, an actuator) that presses the plurality of all-solid-state batteries 1 (the plate 41 on the X1 side) from the X1 side. The pressing force by the pressing part 43 is controlled by the ECU 20. Thereby, the confining pressure of the all-solid-state battery 1 can be controlled.

### All Solid State Battery

FIG. 3 is a diagram schematically showing the configuration of the all-solid-state battery 1. The all-solid-state battery 1 includes a positive electrode layer 2, a negative electrode layer 3, and a solid electrolyte layer 4 as power storage elements. All-solid-state battery 1 may include an exterior body (not shown) for accommodating a power storage element. The exterior body is, for example, a pouch made of a metal foil laminate film.

Note that the battery 10 may be a monopolar stacked battery (parallel-connected stacked battery) or a bipolar stacked battery (series-connected stacked battery). The shape of the battery may be, for example, a coin shape, a laminate shape, a cylindrical shape, or a square shape.

### Positive Electrode Layer

The positive electrode layer 2 includes a positive electrode active material layer 2a and a positive electrode current collector 2b. The positive electrode active material layer 2a is formed by applying a positive electrode slurry to the surface of the positive electrode current collector 2b and drying it. The positive electrode slurry is prepared by kneading the material of the positive electrode active material layer 2a and a solvent. The positive electrode active material layer 2a is in close contact with the solid electrolyte layer 4. The thickness of the positive electrode active material layer 2a is, for example, 0.1 μm or more and 1000 μm or less.

### Negative Electrode Layer

The negative electrode layer 3 includes a negative electrode active material layer 3a and a negative electrode current collector 3b. The negative electrode active material layer 3a is formed by applying a negative electrode slurry to the surface of the negative electrode current collector 3b and drying it. The negative electrode slurry is prepared by kneading the material of the negative electrode active material layer 3a and a solvent. The negative electrode active material layer 3a is in close contact with the solid electrolyte layer 4. The thickness of the negative electrode active material layer 3a is, for example, 0.1 μm or more and 1000 μm or less.

### Solid Electrolyte Layer

Solid electrolyte layer 4 is interposed between positive electrode layer 2 and negative electrode layer 3. Solid electrolyte layer 4 separates positive electrode layer 2 from negative electrode layer 3. The thickness of the solid electrolyte layer 4 is, for example, 0.1 μm or more and 1000 μm or less.

Further, the positive electrode layer 2, the solid electrolyte layer 4, and the negative electrode layer 3 are stacked in the direction in which the plurality of all-solid-state batteries 1 are stacked (X direction). In the example shown in FIG. 3, the positive electrode layer 2 is provided on the X1 side of the solid electrolyte layer 4. In the example shown in FIG. 3, the negative electrode layer 3 is provided on the X2 side of the solid electrolyte layer 4. Note that the positions of the positive electrode layer 2 and the negative electrode layer 3 may be opposite to those shown in FIG. 3.

Here, as shown in FIG. 4, cracks 4a may occur in the solid electrolyte layer 4. When the all-solid-state battery 1 with cracks 4a is charged, metallic lithium 4b is deposited on the solid electrolyte layer 4 from the negative electrode layer 3 side. As the deposited metallic lithium 4b grows, the positive electrode layer 2 and the negative electrode layer 3 may be electrically connected via the metallic lithium 4b. In this case, an internal short circuit occurs in the all-solid-state battery 1.

Therefore, in this embodiment, when an internal short circuit is detected during charging control of the all-solid-state battery 1, the ECU 20 switches from charging control to discharging control and discharges the all-solid-state battery 1. By discharging the all-solid-state battery 1, it is possible to dissolve the deposited metallic lithium 4b.

### How to Charge All-Solid-State Batteries

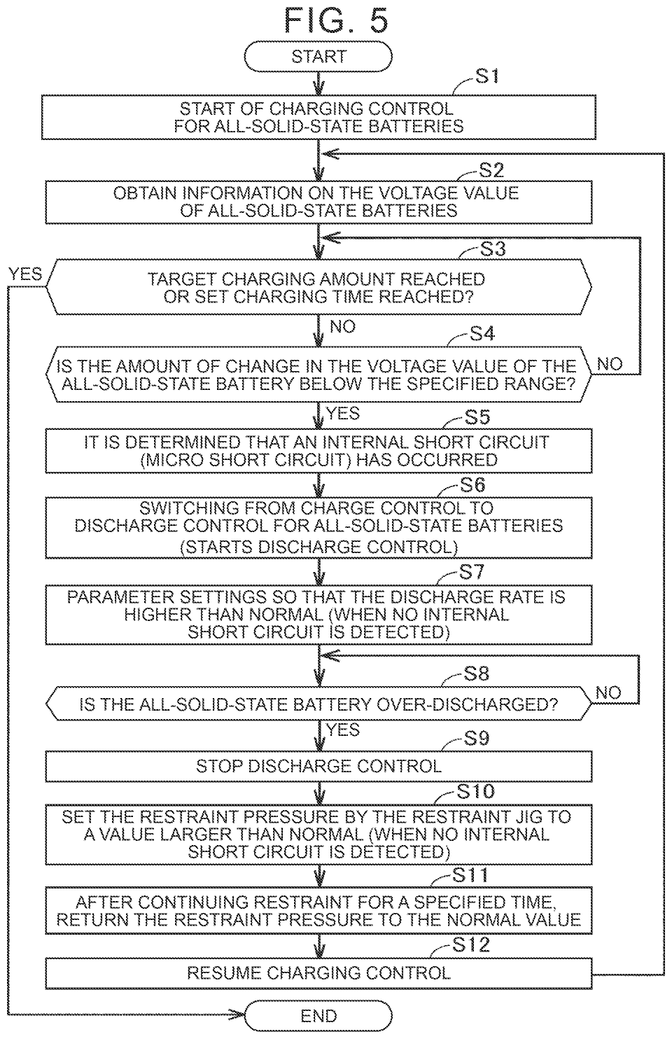

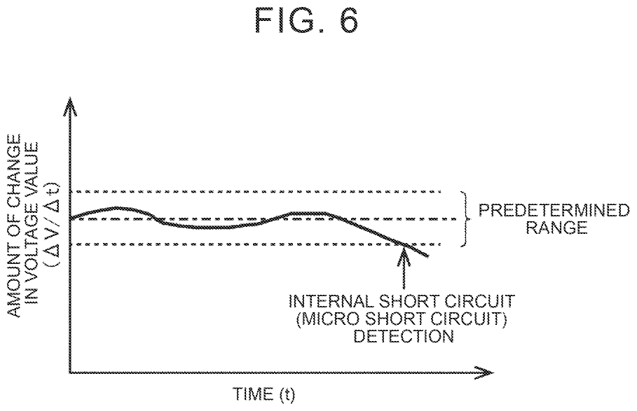

Here, a method for charging the all-solid-state battery 1 while suppressing internal short circuits in the all-solid-state battery 1 will be described with reference to FIGS. 5 and 6.

In S1, the processor 21 of the ECU 20 (hereinafter referred to as ECU 20) starts charging control of the all-solid-state battery 1.

In S2, the ECU 20 acquires information on the voltage value of the all-solid-state battery 1. Specifically, based on the information from the monitoring module 30, the ECU 20 acquires information on the voltage value of each of the plurality of all-solid-state batteries 1.

In S3, the ECU 20 determines whether the amount of charge of the battery 10 has reached the target amount of charge or has reached the preset charging time. If Yes in S3, the process ends. If No in S3, the process proceeds to S4.

In S4, the ECU 20 determines whether an internal short circuit (micro short circuit) is detected in the all-solid-state battery 1. More specifically, it is determined whether the amount of change in the voltage value of the all-solid-state battery 1 is below a predetermined range. The above-mentioned predetermined range is a range centered on the amount of change per unit time in the voltage value of the all-solid-state battery 1 predicted based on the charging current value of the all-solid-state battery 1 (see the dashed line in FIG. 6) (see FIG. 6). The amount of change is expressed as ΔV/Δt. The range is, for example, ±5% of the center value. If the amount of change is below the predetermined range (Yes in S4), the process proceeds to S5. If the amount of change is within the predetermined range (No in S4), the process returns to S3. Note that in S4, if the amount of change in at least one of the plurality of all-solid-state batteries 1 falls below the predetermined range, the process proceeds to S5.

Note that the determination method in S4 is not limited to the above example. For example, the determination may be made based on the absolute value (|V|) of the charging voltage value. For example, the determination may be made based on the amount of change in charging voltage value relative to the amount of change in charging current value (ΔV/ΔI).

Further, in the process of detecting an internal short circuit in the all-solid-state battery 1, the ECU 20 may use, for example, a learned model generated by a machine learning technique such as deep learning. Thereby, it becomes possible to detect (or predict in advance) an internal short circuit in the all-solid-state battery 1 more quickly.

In S5, the ECU 20 determines that an internal short circuit (micro short circuit) has occurred (started to occur) in the all-solid-state battery 1.

In S6, the ECU 20 switches the control of the all-solid-state battery 1 from charging control to discharging control. That is, the ECU 20 starts discharging control of the all-solid-state battery 1. The ECU 20 may perform a process of discharging (supplying) the electric power stored in the all-solid-state battery 1 to the charging/discharging stand 200. Note that the ECU 20 may discharge the electric power stored in the all-solid-state battery 1 through a discharge circuit (not shown) provided in the electrified vehicle 110.

In S7, the ECU 20 sets parameters so that the discharge rate of the all-solid-state battery 1 is higher than normal (when no internal short circuit is detected). For example, the ECU 20 sets the discharge current value of the all-solid-state battery 1 to a value larger than the above-mentioned normal discharge current value (discharge current value during normal external power supply). Even if the discharge rate is increased, the deterioration of the all-solid-state battery 1 will not progress. Therefore, by setting the discharge rate of the all-solid-state battery 1 high, the discharge time can be shortened.

In S8, the ECU 20 determines whether the all-solid-state battery 1 is in an over-discharge state. Here, the voltage value of the all-solid-state battery 1 corresponding to the SOC of the electrified vehicle 110 being 0% is set in advance. In S8, the ECU 20 determines whether the voltage value of at least one of the plurality of all-solid-state batteries 1 has fallen below the voltage value corresponding to SOC 0%. If the all-solid-state battery 1 is in an over-discharge state (Yes in S8), the process proceeds to S9. If the all-solid-state battery 1 is not in an over-discharge state (No in S8), the process in S8 is repeated. By discharging the all-solid-state battery 1 until it reaches an over-discharge state, the metallic lithium 4b deposited in the cracks 4a can be completely dissolved.

Note that in S8, the ECU 20 may determine whether the voltage value of at least one of the plurality of all-solid-state batteries 1 has fallen below the voltage value corresponding to SOC 0% by a predetermined amount or more. In addition, the ECU 20 may determine whether all the voltage values of the plurality of all-solid-state batteries 1 have fallen below the voltage value corresponding to SOC 0%, or have fallen below the voltage value corresponding to SOC 0% by the predetermined amount or more.

In S9, the ECU 20 stops discharging control of the all-solid-state battery 1. In S10, the ECU 20 sets the restraint pressure by the restraint jig 40 (the pressing force by the pressing part 43) to a value larger than the restraint pressure of the restraint jig 40 in normal times (when no internal short circuit is detected). Note that the confining pressure that is larger than normal may be the optimum value for restoring cracks in the all-solid-state battery 1 (bonding the pieces together), which was calculated in tests etc. during the manufacturing stage of the all-solid-state battery 1. The above optimal value is stored in the storage device 23 of the ECU 20.

Moreover, the above-mentioned confining pressure larger than the normal state may be a fixed value set in advance. Note that the confining pressure may be calculated as appropriate based on the degree of internal short circuit predicted based on the amount of change in the voltage value of the all-solid-state battery 1, etc.

It is also conceivable to increase the confining pressure during discharge of the all-solid-state battery 1. However, there is a possibility that metallic lithium remains during discharge of the all-solid-state battery 1. Therefore, as the confining pressure increases, the solid electrolyte layer 4 may be damaged by metallic lithium, and the cracks 4a may expand. By increasing the confining pressure after the discharging of the all-solid-state battery 1 is stopped (that is, after the metallic lithium 4b is dissolved), damage to the solid electrolyte layer 4 can be prevented.

In S11, the ECU 20 continues to restrain the all-solid-state battery 1 for a predetermined time using the restraint pressure set in S10. The predetermined time may be a time calculated in a test or the like during the manufacturing stage of the all-solid-state battery 1. The predetermined time is stored in the storage device 23 of the ECU 20. Thereafter, the ECU 20 performs processing to return the restraint pressure by the restraint jig 40 to the normal value (the restraint pressure when no internal short circuit is detected).

In S12, the ECU 20 resumes charging control of the all-solid-state battery 1. After that, the process returns to S2.

As described above, in this embodiment, when an internal short circuit is detected during charging control of the all-solid-state battery 1, the ECU 20 switches the charging control to the discharging control and causes the all-solid-state battery 1 to discharge. Thereby, when metallic lithium 4b is deposited at a location where an internal short circuit (micro short circuit) has occurred in the all-solid-state battery 1, the metallic lithium 4b can be dissolved by discharging. Furthermore, growth of metallic lithium 4b can be suppressed. As a result, it is possible to suppress the positive electrode layer 2 and the negative electrode layer 3 being completely short-circuited by the metallic lithium 4b.

In the embodiment described above, an example was shown in which discharge control is continued until the all-solid-state battery 1 is over-discharged. However, the present disclosure is not limited thereto. The discharge control may be stopped before the all-solid-state battery 1 enters the over-discharge state.

In the embodiment described above, an example was shown in which the restraint pressure by the restraint jig 40 is increased after the discharge control of the all-solid-state battery 1 is completed. This disclosure is not limited thereto. For example, the confining pressure may begin to increase a predetermined time before the discharge control is completed.

In the embodiment described above, an example was shown in which the discharge rate of the all-solid-state battery 1 after an internal short circuit is detected is made higher than the discharge rate when no internal short circuit is detected. However, the present disclosure is not limited thereto. The discharge rate of the all-solid-state battery 1 after an internal short circuit is detected may be lower than the discharge rate when no internal short circuit is detected.

In the above embodiment, an example is shown in which the all-solid-state battery system 100 is mounted on an electrified vehicle. However, the present disclosure is not limited thereto. All-solid-state battery system 100 may be mounted on, for example, a stationary power storage device.

Note that the configurations (processing) of the above-described embodiment and each of the above-described modifications may be combined with each other.

The embodiment disclosed herein should be considered as illustrative and not restrictive in all respects. The scope of the present disclosure is indicated by the claims rather than the description of the embodiments described above. The scope of the present disclosure is intended to include all changes within the meaning and range equivalent to the claims.

What is claimed is:

1. An all-solid-state battery system comprising:
an all-solid-state battery; and
a control device that performs charge control and discharge control of the all-solid-state battery, wherein when an internal short circuit is detected during the charge control of the all-solid-state battery, the control device switches the charge control to the discharge control and discharges the all-solid-state battery.

2. The all-solid-state battery system according to claim 1, wherein when the internal short circuit is detected during the charge control of the all-solid-state battery, the control device continues the discharge control until the all-solid-state battery is over-discharged.

3. The all-solid-state battery system according to claim 1, further comprising
a restraint jig for restraining the all-solid-state battery, wherein the control device increases a restraint pressure by the restraint jig when the internal short circuit is detected during the charge control of the all-solid-state battery, compared to when the internal short circuit is not detected.

4. The all-solid-state battery system according to claim 3, wherein the control device increases the restraint pressure after the discharge control of the all-solid-state battery is completed.

5. The all-solid-state battery system according to claim 1, wherein the control device increases a discharge rate of the all-solid-state battery when the internal short circuit is detected during the charge control of the all-solid-state battery, compared to when the internal short circuit is not detected.
